(19) United States
(12) Patent Application Publication
(10) Pub. No.: US 2026/0160119 A1
(43) Pub. Date: Jun. 11, 2026

(54) SIDE-HUNG DOOR

(71) Applicant: Xiaojie LIU, Dalian City (CN)

(72) Inventor: Xiaojie LIU, Dalian City (CN)

(73) Assignee: TDK DOORS INC., VANCOUVER (CA)

(21) Appl. No.: 18/977,881

(22) Filed: Dec. 11, 2024

(51) Int. Cl. E06B 3/82; E05D 7/081; E06B 3/70; E06B 7/23

(52) U.S. Cl. CPC E06B 3/822; E05D 7/081; E06B 7/231; E06B 2003/7074

(57) ABSTRACT

A side-hung door, includes a door frame device and a door panel. The door frame device includes a door post, a rotatable connecting member, and a door frame. The door post is provided with an insertion slot; the rotatable connecting member is inserted into the insertion slot; the door frame includes a door post frame and a door panel frame; the door post frame is connected to the door panel frame; the door post frame is provided with a positioning slot; the door post is inserted into the positioning slot; the door post is connected to the door panel frame. The door panel is connected to the door frame, and the door panel is covered at the door frame device.

### TECHNICAL FIELD

The present invention relates to the technical field of doors and windows, and in particular, to a side-hung door.

### BACKGROUND OF THE INVENTION

Side-hung doors have been widely used in many fields due to their advantages of easy operation and easy maintenance. The side-hung doors are usually provided with sealing strips, which can effectively isolate sound, dust, hot and cold air, and the like, so that the side-hung doors are particularly popular in environments that need to be highly isolated and controlled. At present, the side-hung door on the market is mainly composed of a door frame, a [0003] door post, and a door panel. Generally, the door post is arranged around the door panel, which is not aesthetically pleasing. Furthermore, the door post is usually of a single-layer structure which is unstable and not strong enough, and has low strength. Without a cold cutting bridge, the thermal insulation effect is poor. Due to an exposure design of the door post, the door panel does not wrap around the door post, so that the product is not beautiful, is difficult to clean, and is prone to deformation during use.

Therefore, the present invention provides a side-hung door which can effectively solve the above problems. The side-hung door is simple and beautiful in structure, and has stabilization and sturdiness effects, which can effectively ensure the sealing and thermal insulation effects of the side-hung door.

### SUMMARY OF THE INVENTION

In order to overcome the shortcomings of the prior art, the present invention provides a side-hung door. The side-hung door is simple and beautiful in structure, and has stabilization and sturdiness effects, which can effectively ensure the sealing and thermal insulation effects of the side-hung door.

The technical solution adopted by the present invention to solve the technical problem is as follows.

A side-hung door, includes a door frame device and a door panel.

The door frame device includes a door post, a rotatable connecting member, and a door frame. The door post is provided with an insertion slot; the rotatable connecting member is inserted into the insertion slot; the door frame includes a door post frame and a door panel frame; the door post frame is connected to the door panel frame; the door post frame is provided with a positioning slot; the door post is inserted into the positioning slot; the door post is connected to the door panel frame. The door panel is connected to the door frame, and the door panel is covered at the door frame device.

As an improvement of the present invention, the side-hung door further includes two angle brackets. The two angle brackets connect the door post to the door panel frame.

As an improvement of the present invention, an opening is provided in an outer side of the door post; the angle brackets are of L-shaped structures; one end of each of the two angle brackets is located at each of a top and a bottom of the outer side of the door post, and the other ends of the two angle brackets are respectively located at an upper end and a lower end of an inner side of the door panel frame; and the angle brackets are at least partially located in the opening.

As an improvement of the present invention, an oblate insertion slot is provided in the door post; the rotatable connecting member is provided with an insertion part; the insertion part is inserted into the insertion slot; and the insertion part is oblate.

As an improvement of the present invention, the insertion part extends outwards along an upper surface and a lower surface of the door post to form a rotating part, and an end surface of the rotating part is matched with a height of the door panel frame.

As an improvement of the present invention, the door panel frame is provided with a notch, and the rotating part is located in the notch.

As an improvement of the present invention, at least one rotatable connecting member is provided.

As an improvement of the present invention, the door panel frame includes an outer door panel frame and an inner door panel frame; a shape and size of the inner door panel frame are matched with a shape and size of the outer door panel frame; and the inner door panel frame is nested into the outer door panel frame.

As an improvement of the present invention, the inner door panel frame is approximately of a rectangular plate-like structure.

As an improvement of the present invention, the door panel frame includes a top frame, a bottom frame, and a side frame; and at least two of the top frame, the bottom frame, and the side frame are detachably connected.

As an improvement of the present invention, the side-hung door further includes a first sealing element, the door post frame is provided with a first mounting slot and a first slot communicated to the first mounting slot; the first sealing element is at least partially inserted into the first mounting slot; and the first sealing element is at least partially threaded out along the first slot.

As an improvement of the present invention, at least one first mounting slot is provided; and a number of the first slot, a number of the first sealing element, and a number of the first mounting slot are the same.

As an improvement of the present invention, the side-hung door further includes a second sealing element, a second mounting slot and a second slot communicated to the second mounting slot are provided in an outer edge of the outer door panel frame; the second sealing element is at least partially inserted into the second mounting slot; and the second sealing element is at least partially threaded out along the second slot.

As an improvement of the present invention, the second mounting slot and the second slot communicated to the second mounting slot are provided on at least part of the outer edge of the outer door panel frame.

As an improvement of the present invention, at least one second mounting slot is provided; and a number of the second slot, a number of the second sealing element, and a number of the second mounting slot are the same.

As an improvement of the present invention, the first sealing element and the second sealing element are made of soft materials.

As an improvement of the present invention, the door panel is at least partially covered at an outer surface of the door frame, and a shape and size of the door panel are matched with a shape and size of the door frame.

As an improvement of the present invention, two door panels are provided; and the two door panels are correspondingly fixed to a front surface and a rear surface of the door panel frame; and an isolation space is formed between the two door panels and an inner surface of the door panel frame.

As an improvement of the present invention, the door post frame is provided with several cavities, and the cavities are configured for thermal isolation.

As an improvement of the present invention, at least one observation window is provided in the door panel; the observation windows on the two door panels correspond to each other; and a transparent or semi-transparent cover plate is arranged at each observation window.

Beneficial effects: By the arrangement of the above structure, according to the design where the door post frame is wrapped around the door post and the door panels are wrapped around the door frame device, the door post is hidden in the door post frame, and the door frame device is hidden between the door panels, so that the entire side-hung door is beautiful and neat. This not only improves the structural stability of the side-hung door, but also improves the thermal insulation performance of the side-hung door and enhances the sealing effect of the side-hung door. During use, if the side-hung door is closed, several cavities of the door post frame and an isolation space are filled with air. The thermal conductivity of air is low, which can effectively achieve thermal isolation and a good thermal insulation effect. Meanwhile, sealing elements arranged at the door panel frame and an outer edge of the door post frame can better achieve a sealing property. The side-hung door has a stable structure and a good sealing effect, can effectively block dust and other impurities and ensure cleanliness inside the door. The side-hung door has a simple structure and a good sealing and thermal insulation effect.

### BRIEF DESCRIPTION OF DRAWINGS

In order to explain the technical solutions of the embodiments of the present invention more clearly, the following will briefly introduce the accompanying drawings used in the embodiments. The drawings in the following description are only some embodiments of the present invention. Those of ordinary skill in the art can obtain other drawings based on these drawings without creative work.

The present invention is further described below in detail in combination with the accompanying drawings and embodiments.

FIG. 1 is a schematic diagram of an entire structure in an angle according to a first embodiment of the present invention;

FIG. 2 is a schematic diagram of an entire structure in another angle according to a first embodiment of the present invention;

FIG. 3 is a schematic exploded structural diagram according to a first embodiment of the present invention;

FIG. 4 is a schematic exploded structural diagram of a door frame device according to a first embodiment of the present invention;

FIG. 5 is a front view according to a first embodiment of the present invention;

FIG. 6 is a front view of a mounted state according to a first embodiment of the present invention;

FIG. 7 is a schematic cross-sectional structural view according to a first embodiment of the present invention;

FIG. 8 is an enlarged view of circle A in FIG. 4;

FIG. 9 is an enlarged view of circle B in FIG. 4;

FIG. 10 is a cross-sectional view of a mounted state according to a first embodiment of the present invention;

FIG. 11 is a schematic diagram of an entire structure in an angle according to a second embodiment of the present invention;

FIG. 12 is a schematic diagram of an entire structure in another angle according to a second embodiment of the present invention;

FIG. 13 is a schematic exploded structural diagram according to a second embodiment of the present invention;

FIG. 14 is a schematic exploded structural diagram of a door frame device according to a second embodiment of the present invention;

FIG. 15 is a front view according to a second embodiment of the present invention;

FIG. 16 is a front view of a mounted state according to a second embodiment of the present invention;

FIG. 17 is a schematic cross-sectional structural view according to a second embodiment of the present invention;

FIG. 18 is an enlarged view of circle C in FIG. 4;

FIG. 19 is an enlarged view of circle D in FIG. 4;

FIG. 20 is a cross-sectional view of a mounted state according to a second embodiment of the present invention;

FIG. 21 is a schematic diagram of an entire structure in an angle according to a third embodiment of the present invention;

FIG. 23 is a schematic diagram of an entire structure in another angle according to a third embodiment of the present invention;

FIG. 23 is a schematic exploded structural diagram according to a third embodiment of the present invention;

FIG. 24 is a schematic exploded structural diagram of a door frame device according to a third embodiment of the present invention;

FIG. 25 is a front view according to a third embodiment of the present invention;

FIG. 26 is a front view of a mounted state according to a third embodiment of the present invention;

FIG. 27 is a schematic cross-sectional structural view according to a third embodiment of the present invention;

FIG. 28 is an enlarged view of circle E in FIG. 4;

FIG. 29 is an enlarged view of circle F in FIG. 4; and

FIG. 30 is a cross-sectional view of a mounted state according to a third embodiment of the present invention.

### DETAILED DESCRIPTION OF THE INVENTION

To make the aforementioned objectives, features, and advantages of the present invention more comprehensible, specific implementations of the present invention are described in detail below in conjunction with the accompanying drawings. In the following description, numerous specific details are set forth to provide a thorough understanding of the present invention. The present invention may, however, be embodied in many forms different from that described here. A person skilled in the art can make similar improvements without departing from the connotation of the present invention. Therefore, the present invention is not limited by the specific embodiments disclosed below.

In the description of the present invention, It is to be understood that, The terms “center”, “longitudinal”, “transverse”, “upper”, “lower”, “front”, “rear”, “left”, “right”, “vertical”, “horizontal”, “top”, “bottom”, “inner”, “outer”, “clockwise”, “counterclockwise”, and the like indicate azimuth or positional relationships based on the azimuth or positional relationships shown in the drawings, for purposes of convenience only of describing the present invention and simplifying the description, Rather than indicating or implying that the indicated device or element must have a particular orientation, be constructed and operated in a particular orientation, therefore, not to be construed as limiting the present invention.

In addition, the terms “first” and “second” are used for descriptive purposes only, while not to be construed as indicating or implying relative importance or implicitly specifying the number of technical features indicated thereby, features defining “first,” “second,” and “second” may explicitly or implicitly include one or more of the described features. In the description of the present invention, “multiple” means two or more unless explicitly specified otherwise. In addition, the terms “install”, “arrange”, “provide”, “connect” and “couple” should be [0064] understood broadly. For example, it can be a fixed connection, a detachable connection, an integral structure, a mechanical connection, an electrical connection, a direct connection, an indirect connection through an intermediate medium, or a communication between two devices, elements or components. For ordinary technical personnel in this field, the specific meanings of the above terms in present invention can be understood based on specific circumstances.

In the present invention, unless specific regulation and limitation otherwise, the first feature “onto” or “under” the second feature may include the direct contact of the first feature and the second feature, or may include the contact of the first feature and the second feature through other features between them instead of direct contact. Moreover, the first feature “onto”, “above” and “on” the second feature includes that the first feature is right above and obliquely above the second feature, or merely indicates that the horizontal height of the first feature is higher than the second feature. The first feature “under”, “below” and “down” the second feature includes that the first feature is right above and obliquely above the second feature, or merely indicates that the horizontal height of the first feature is less than the second feature.

It should be noted that when an element is referred to as being “fixed to” another element, the element can be directly on another component or there can be a centered element. When an element is considered to be “connected” to another element, the element can be directly connected to another element or there may be a centered element. The terms “inner”, “outer”, “left”, “right”, and similar expressions used herein are for illustrative purposes only and do not necessarily represent the only implementation.

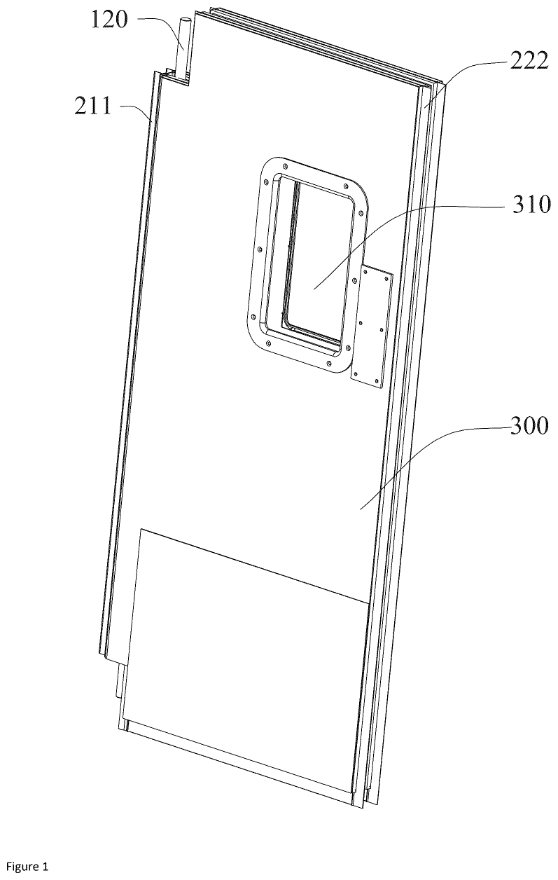

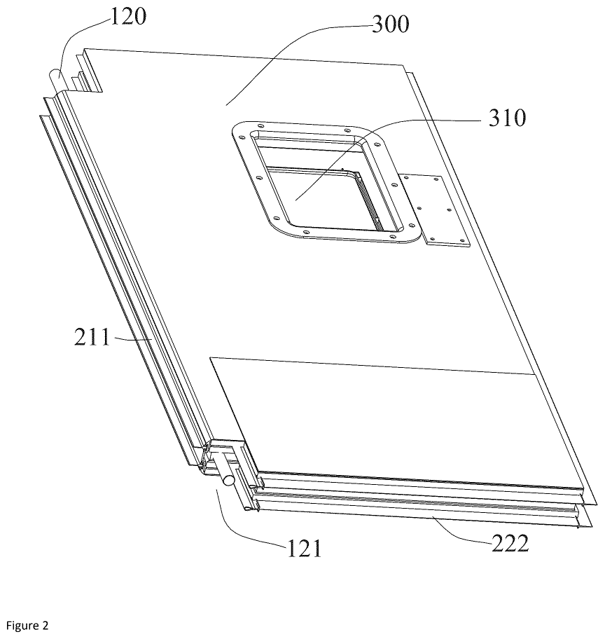

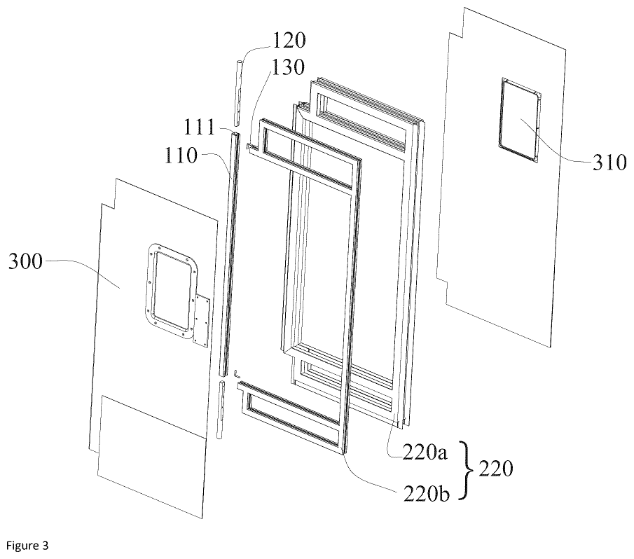

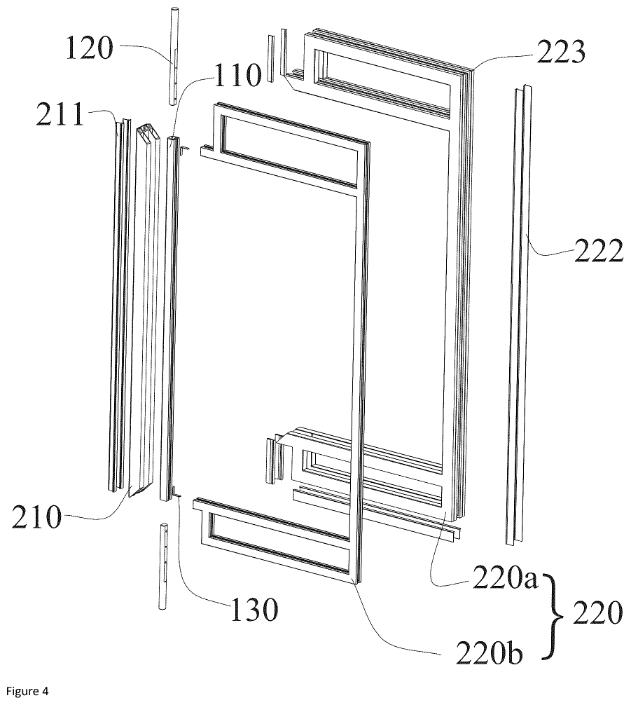

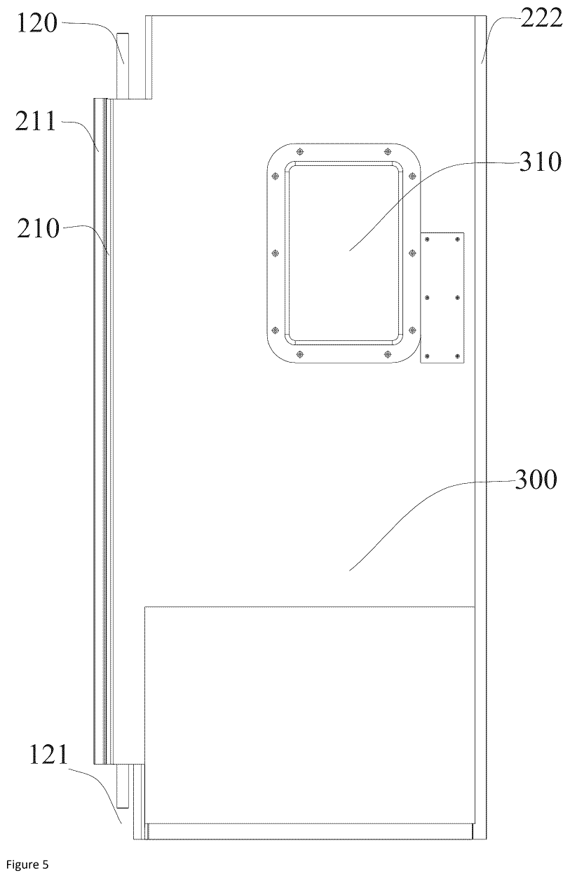

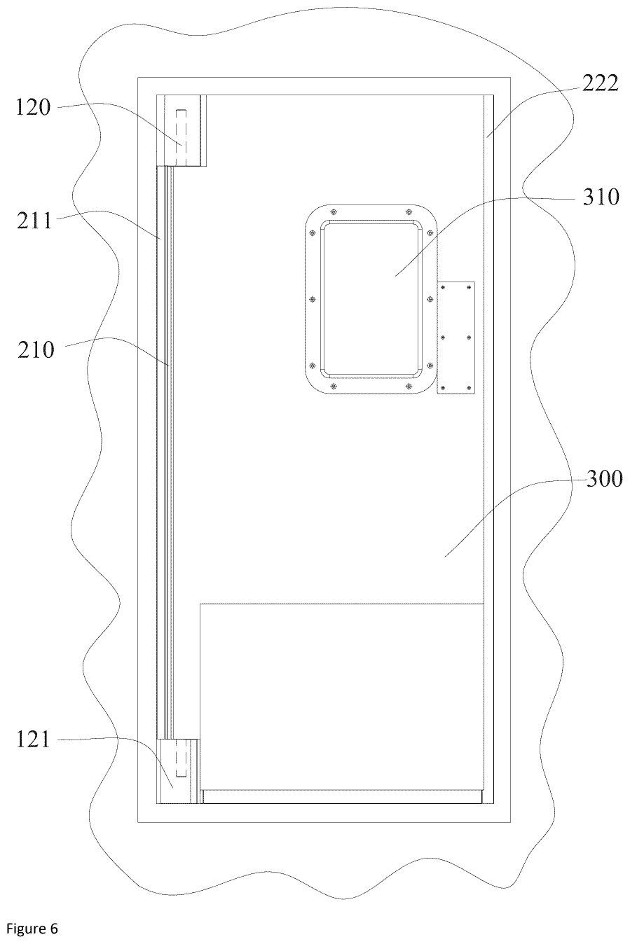

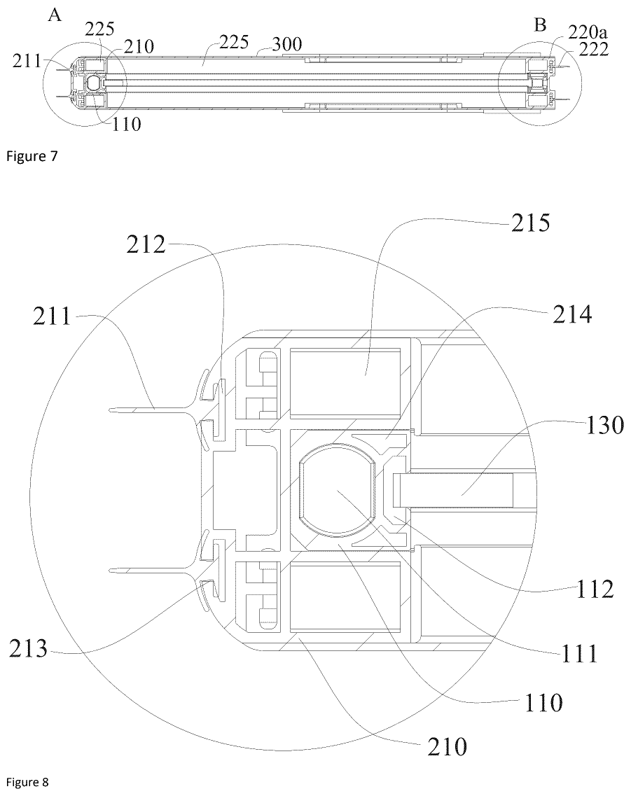

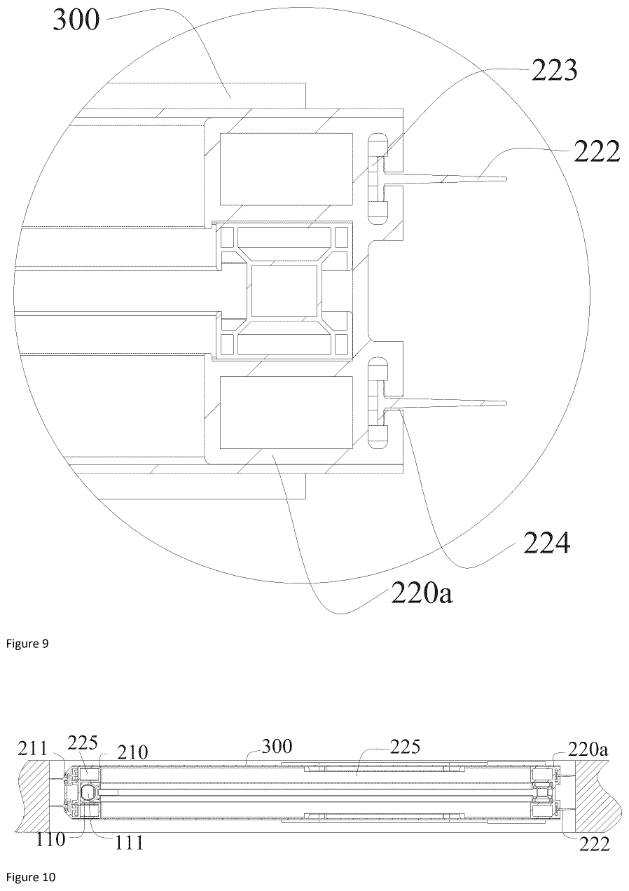

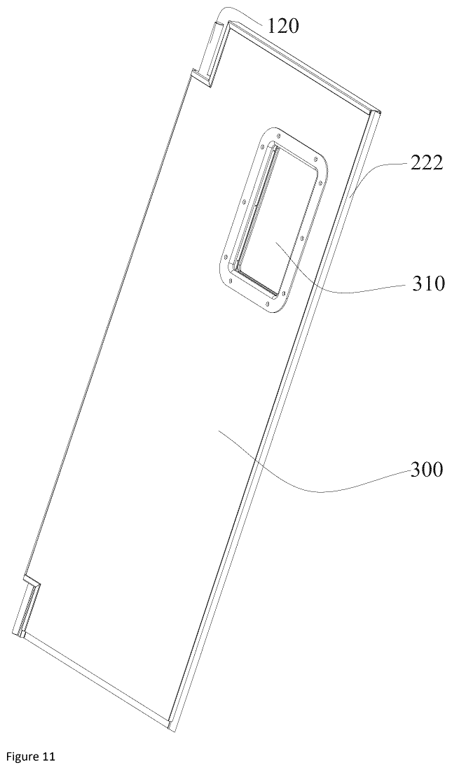

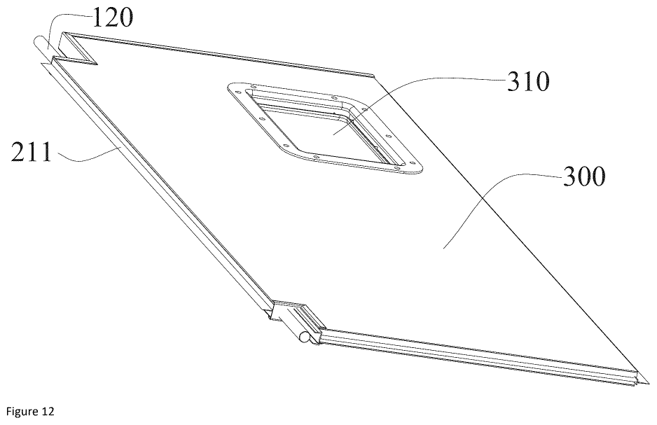

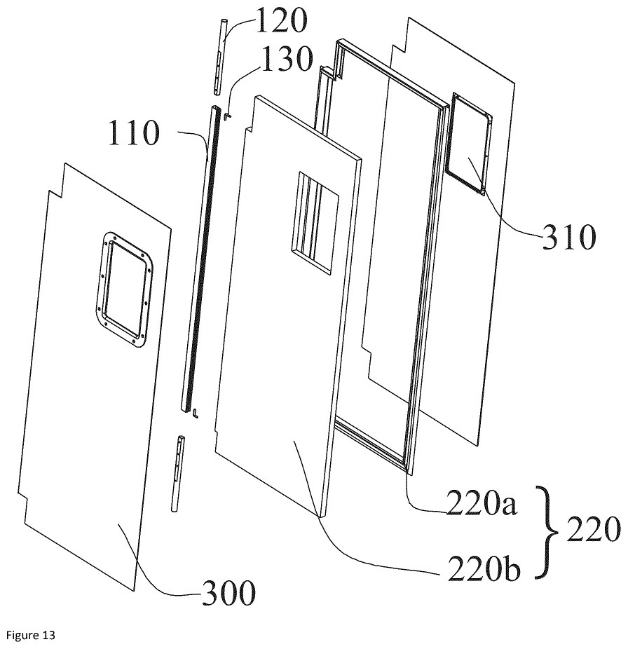

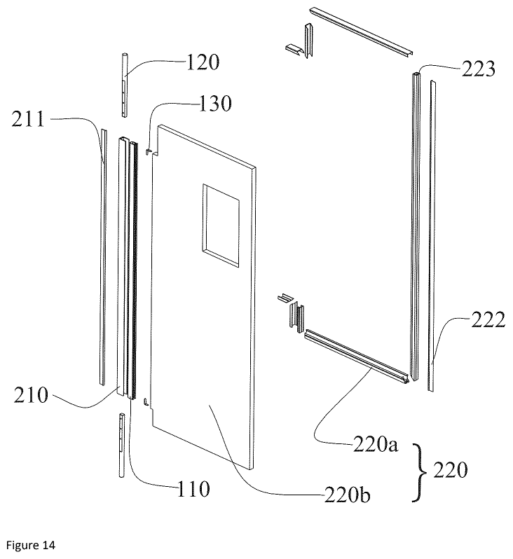

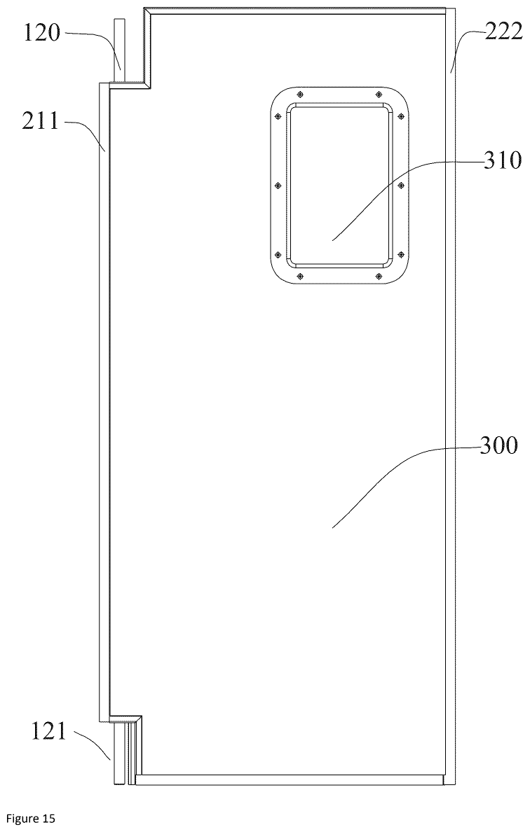

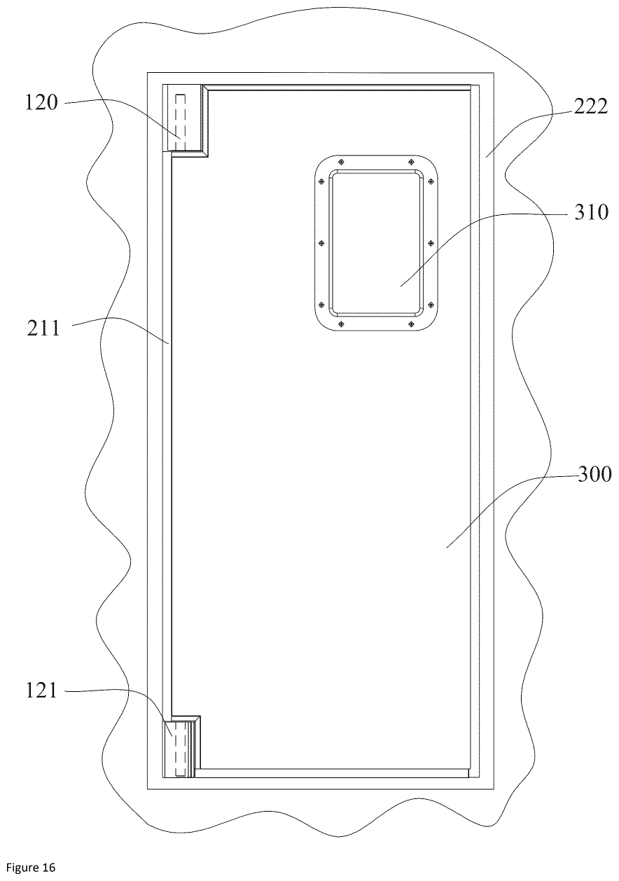

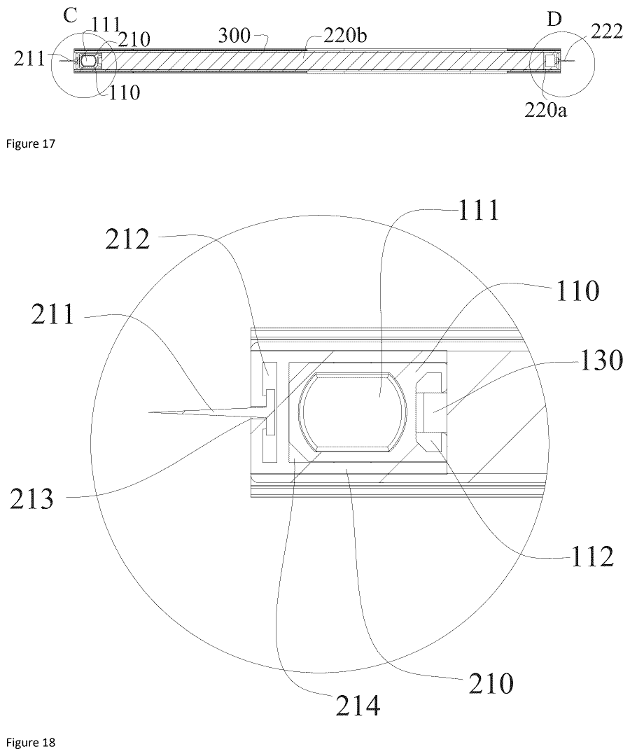

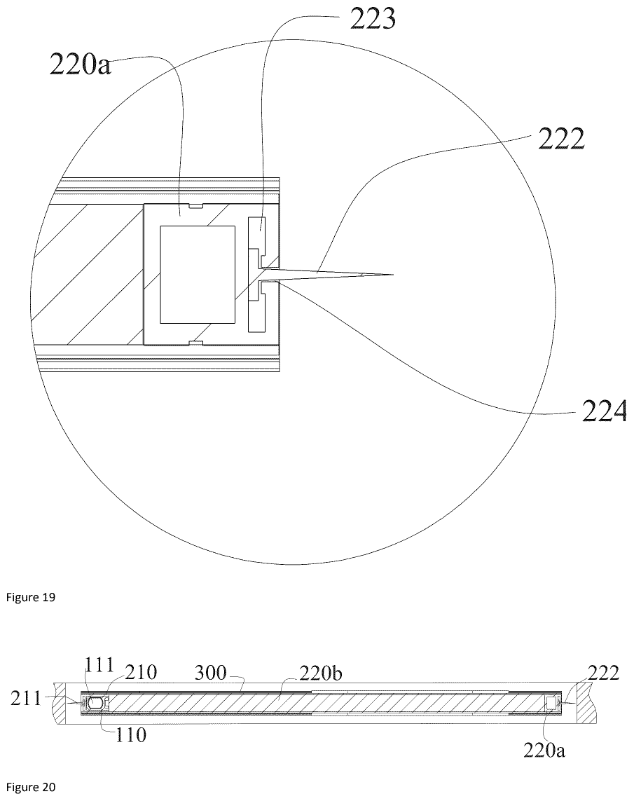

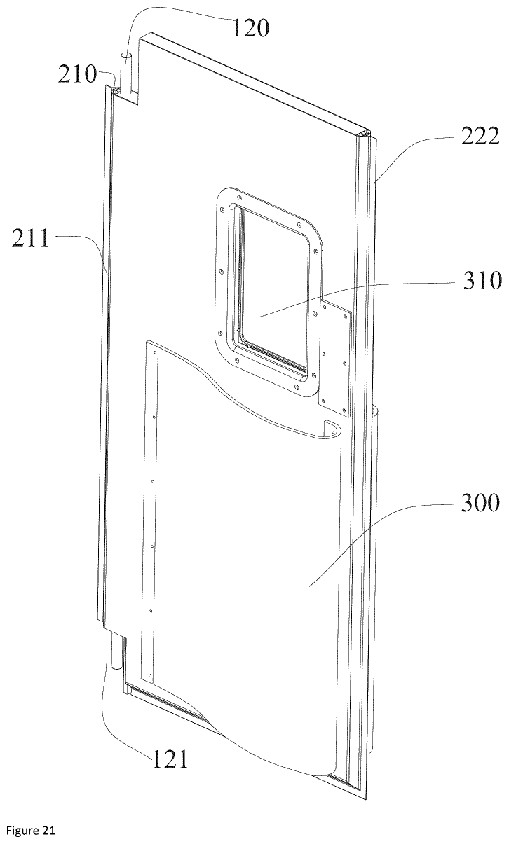

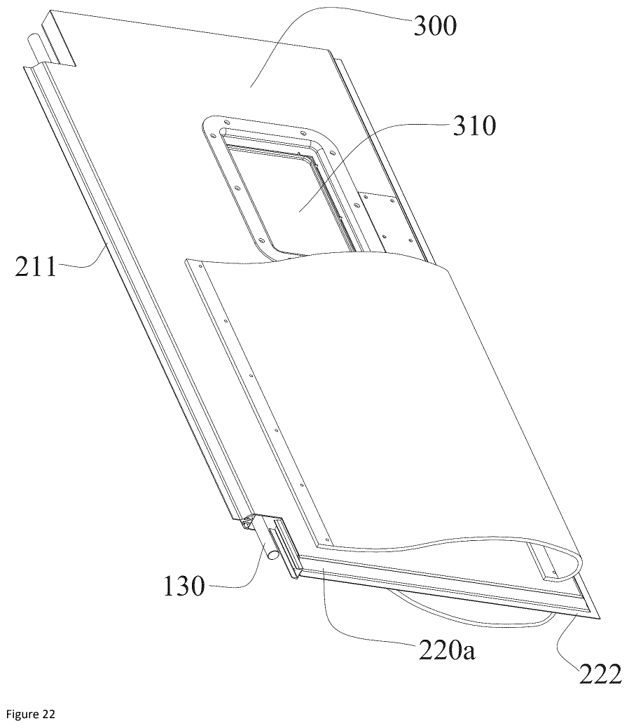

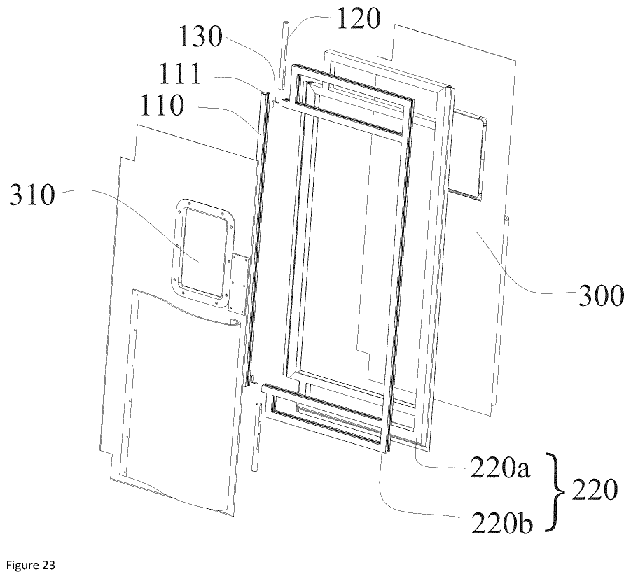

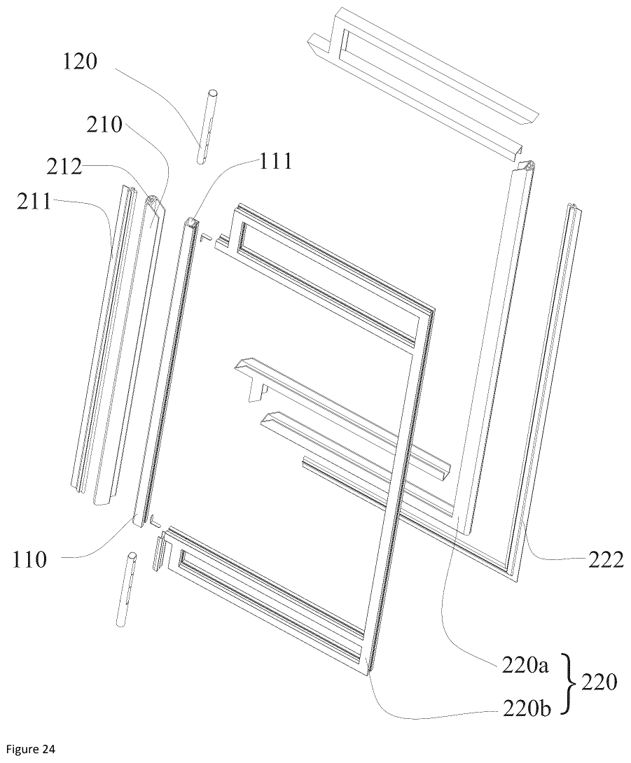

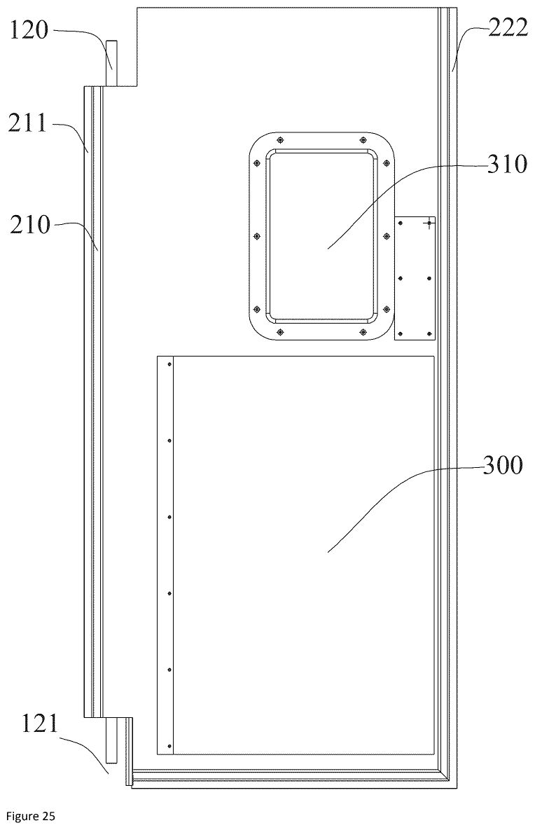

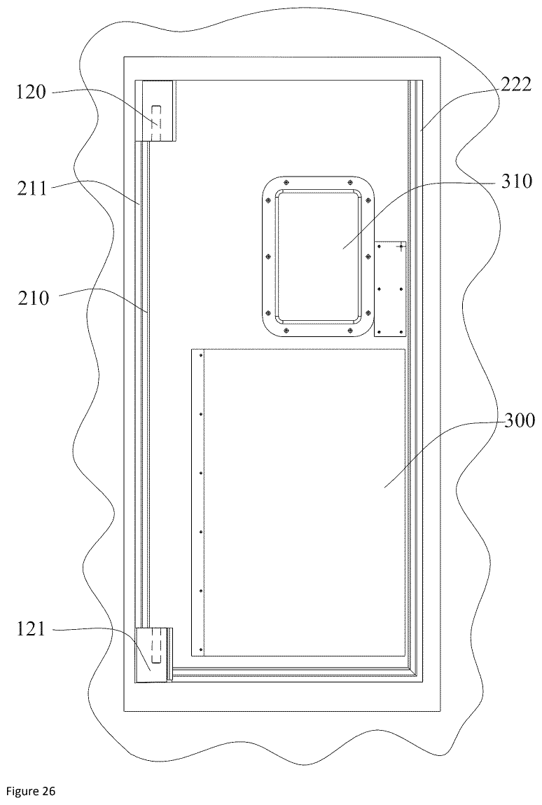

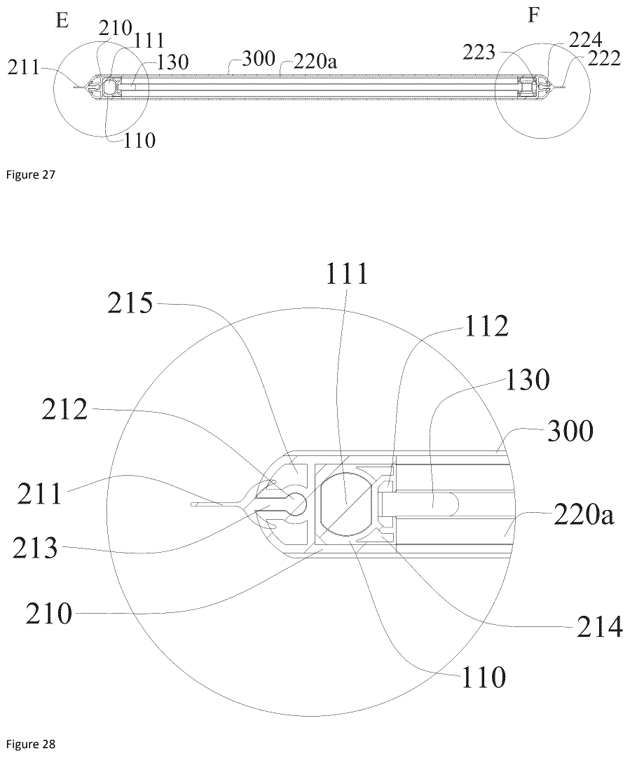

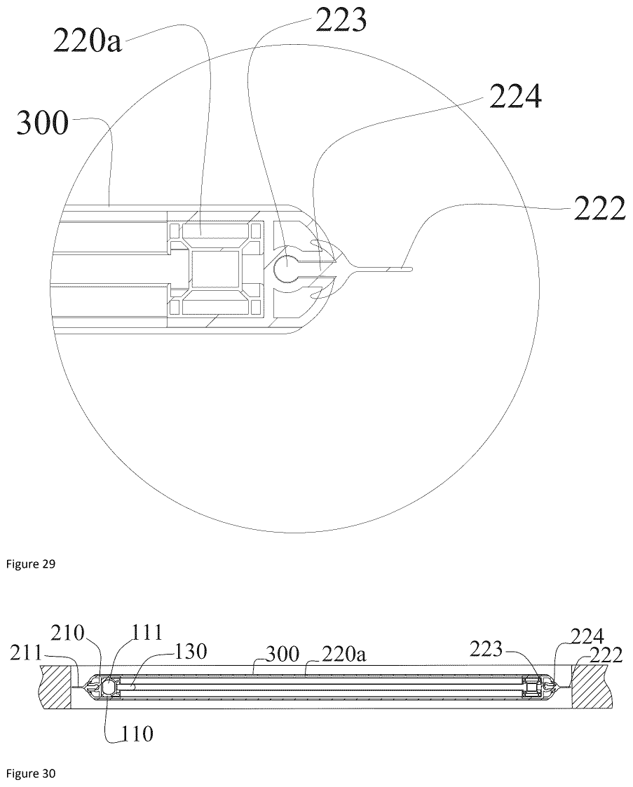

Referring to FIG. 1 to FIG. 30, a side-hung door includes:
a door frame device, including a door post 110, a rotatable connecting member 120, and a door frame 200, wherein the door post 110 is provided with an insertion slot 111; the rotatable connecting member 120 is inserted into the insertion slot 111; the door frame 200 includes a door post frame 210 and a door panel frame 220; the door post frame 210 is connected to the door panel frame 220; the door post frame 210 is provided with a positioning slot 214; the door post 110 is inserted into the positioning slot 214; the door post 110 is connected to the door panel frame 220; and
door panels 300, wherein the door panels 300 are connected to the door frame 200, and the door panels 300 are covered at the door frame device.

By the arrangement of the above structure, according to the design where the door post frame 210 is wrapped around the door post 110 and the door panels 300 are wrapped around the door frame device, the door post 110 is hidden in the door post frame 210, and the door frame device is hidden between the door panels 300, so that the entire side-hung door is beautiful and neat. This not only improves the structural stability of the side-hung door, but also improves the thermal insulation performance of the side-hung door and enhances the sealing effect of the side-hung door. During use, if the side-hung door is closed, several cavities 215 of the door post frame 210 and an isolation space 230 are filled with air. The thermal conductivity of air is low, which can effectively achieve thermal isolation and a good thermal insulation effect. Meanwhile, sealing elements arranged at the door panel frame 220 and an outer edge of the door post frame 210 can better achieve a sealing property. The side-hung door has a stable structure and a good sealing effect, can effectively block dust and other impurities and ensure cleanliness inside the door. The side-hung door has a simple structure and a good sealing and thermal insulation effect.

In this embodiment, the side-hung door further includes two angle brackets 130. The two angle brackets 130 connect the door post 110 to the door panel frame 220. By the arrangement of the above structure, the door post 110 is connected to the door panel frame 220 using the angle bracket 130, so that assembling between the door post 110 and the door panel frame 220 is easier and faster. The two angle brackets 130 ensure more stable connection between the door post 110 and the door panel frame 220.

In this embodiment, an opening 112 is provided in an outer side of the door post 110. The angle brackets 130 are of L-shaped structures. One end of each of the two angle brackets 130 is located at each of a top and a bottom of the outer side of the door post 110, and the other ends of the two angle brackets 130 are respectively located at an upper end and a lower end of an inner side of the door panel frame 220. The angle brackets 130 are at least partially located in the opening 112. By the arrangement of the above structure, due to the design of the opening in the outer side of the door post 110, the door post 110 is connected to the door panel frame 220 by the L-shaped angle brackets 130, thereby improving the connection strength between them and ensuring the robustness and stability of the structure of the entire side-hung door. Meanwhile, the top and the bottom are places where force is most concentrated. The angle bracket 130 at the top ensures the stability of the upper part of the door frame device, and the angle bracket 130 at the bottom ensures the stability of the lower part of the door frame device. The position setting for the angle brackets 130 ensures the structural stability of the entire door frame device, reduces damage to the side-hung door caused by excessive local force, and improves the safety, stability, and service life of the overall structure.

In this embodiment, an oblate insertion slot 111 is provided in the door post 110. The rotatable connecting member 120 is provided with an insertion part. The insertion part is inserted into the insertion slot 111. The insertion part is oblate. By the arrangement of the above structure, due to a special structural design, the insertion slot 111 in the door post 110 is designed to be oblate, and the insertion part is also designed to be oblate, so that the rotatable connecting member may not move or twist inside the door post 110 during the rotation of the side-hung door, thereby ensuring sturdier combination between a insertion part and the insertion slot 111. Preferably, the door post 110 is made of an aluminum alloy material. Aluminum alloy has high strength and can provide good support and stability, which ensures that the door post 110 does not easily deform during long-term use. The high rigidity of the aluminum alloy can effectively resist external impact and pressure, which reduces the problem of unstable mounting of the rotatable connecting member 120 caused by frequent opening and closing of the side-hung door, and improves the stability of the entire side-hung door. Meanwhile, the corrosion resistance and the oxidation resistance of the aluminum alloy reduce the maintenance frequency and the usage costs. Preferably, the door post 110 is located in the middle of the door post frame 210, and the insertion slot 111 is provided in the middle of the door post 110. The insertion part is inserted into the insertion slot 111, which can achieve stable connection between the rotatable connecting member 120 and the door post frame 210, thereby improving the overall stability of the side-hung door.

In this embodiment, the insertion part extends outwards along an upper surface and a lower surface of the door post 110 to form a rotating part, and an end surface of the rotating part is matched with a height of the door panel frame 220. By the arrangement of the above structure, the end surface of the rotating part is matched with the height of the door panel frame 220, which can ensure that the rotatable connecting member can accurately align the height of the door panel frame 220 with the height of a mounting wall during mounting, to avoid the problem that the side-hung door tilts or the side-hung door cannot be opened and closed normally because of inconsistent heights. Preferably, the rotatable connecting member 120 is a rotating shaft that can provide a smooth rotation motion, so that it ensures that the side-hung door may not be jammed or resisted during opening and closing. The rotating shaft is relatively easy to mount and convenient to maintain in the later stage. Regularly adding a lubricant can further ensure smooth rotation of the rotating shaft during long-term use.

In this embodiment, a notch 121 is provided in the door panel frame 220, and the rotating part is located in the notch 121. By the arrangement of the above structure, the notch 121 provides an enough space for the rotation of the rotatable connecting member 120, so that the side-hung door can be freely opened and closed without obstruction. Meanwhile, the presence of the notch 121 makes the mounting and removal of the rotatable connecting member 120 more convenient. This design provides a better rotation space, higher structural stability, and easier mounting and maintenance for the side-hung door.

In this embodiment, at least one rotatable connecting member 120 is provided. By the arrangement of the above structure, when there is one rotatable connecting member 120, the rotatable connecting member 120 penetrates through the entire insertion slot 111. Due to the design of the single rotatable connecting member 120, the overall structure of the side-hung door is simpler, which can provide higher supporting force and ensure that the side-hung door is more stable during opening and closing. When there are two rotatable connecting members 120, the insertion parts of the two rotatable connecting members 120 are respectively inserted into a top end and a bottom end of the insertion slot 111. The two rotatable connecting members 120 can better share the weight of the side-hung door, reduce single-point stress, and improve the overall stability and the overall load-bearing capacity.

In this embodiment, the door panel frame 220 includes an outer door panel frame 220a and an inner door panel frame 220b. A shape and size of the inner door panel frame 220b are matched with a shape and size of the outer door panel frame 220b. The inner door panel frame 220b is nested into the outer door panel frame 220a. By the arrangement of the above structure, the door panel frame 220 is designed in two parts: the outer door panel frame 220a and the inner door panel frame 220b, and the inner door panel frame 220b is nested into the outer door panel frame 220a. The double-layer structure can improve the stability of the entire door panel frame 220 and reduce deformation and looseness caused by an external impact or frequent opening and closing of the side-hung door. Meanwhile, designing two parts is convenient for mounting and later maintenance and adjustment. If a frame is damaged, this frame can be replaced alone, without replacing the entire door panel frame 220. Preferably, the door panel frame 220 is made of aluminum alloy which has good corrosion resistance, is not easily rusted, and is suitable for use in various environments. Meanwhile, the aluminum alloy is relatively light, so that the weight of the door panel frame 220 is reduced. In addition, as the aluminum alloy is an environmentally-friendly material, aluminum alloy waste generated during production can be recycled, which meets the requirement of sustainable development.

In this embodiment, the inner door panel frame 220b is approximately of a rectangular plate-like structure. By the arrangement of the above structure, the inner door panel frame 220b with the solid plate-like structure has high strength, which can effectively resist an external impact and pressure and lower the risk of deformation and damage. The solid structure can better bear a heavy load, to ensure that the side-hung door can remain stable and sturdy after long-term use. The inner door panel frame 220b with the solid structure can be in close fit with the door panels 300, thereby reducing gaps in the door panel frame 220 and enhancing the sealing effect. Preferably, the inner door panel frame 220b is provided with a window. When the door panels 300 are covered at the door frame 200, a position, shape, and size of the window are matched with those of the observation windows 310. Preferably, the inner door panel frame 220b can be a core material such as a solid plate, a foam sheet, and a honeycomb plate. The solid plate does not easily deform and can maintain a good shape and structure after long-term use. The foam plate contains a large amount of air inside, so it is overall light in weight. A foam material has good thermal insulation performance, which can effectively isolate an internal temperature from an external temperature. The honeycomb plate can reduce the weight of the inner door panel frame 220b while ensuring sufficient strength. The structure of the honeycomb plate can also improve the thermal insulation performance of the inner door panel frame 220b.

In this embodiment, the door panel frame 220 includes a top frame, a bottom frame, and a side frame. At least two of the top frame, the bottom frame, and the side frame are detachably connected. By the arrangement of the above structure, the detachably connected top frame, bottom frame, and side frame divide the door panel frame 220 into a plurality of parts for ease of mounting and removal. This design not only simplifies the mounting process, but also facilitates later maintenance and repair. If a part of the frame is damaged or needs to be replaced, this can be replaced alone, without replacing the entire door panel frame 220, so that the maintenance costs are reduced. In addition, the door panel frame 220 after division occupies a small space, making it easy for transportation and storage. A user can also flexibly choose and configure different top frames, bottom frames, and side frames according to own needs and preferences.

In this embodiment, the side-hung door further includes a first sealing element 211. The door post frame 210 is provided with a first mounting slot 212 and a first slot 213 communicated to the first mounting slot 212. The first sealing element 211 is at least partially inserted into the first mounting slot 212. The first sealing element 211 is at least partially threaded out along the first slot 213. By the arrangement of the above structure, during the mounting of the side-hung door, the door post frame 210 and the mounting wall cannot be perfectly aligned, which may cause a gap when the side-hung door is opened and closed, affecting the sealing property and thermal insulation effect of the side-hung door. Due to the design of the first sealing element 211, problems caused by the gap can be effectively compensated for. During assembling, the first sealing element 211 is inserted into the first mounting slot 212, and the first sealing element 211 is threaded out along the first slot 213. The first mounting slot 212 can effectively fix the first sealing element 211 and prevent the first sealing element 211 from falling off during the opening or closing of the side-hung door. The first sealing element 211 threaded out of the first slot 213 protrudes out of an end surface. When the side-hung door is in a closed state, an end of the first sealing element 211 is in contact with an inner surface of the mounting wall to cover the gap generated during the mounting, thereby effectively achieving a sealing effect. In this embodiment, at least one first mounting slot 212 is provided. A number of the [0081] first slot, a number of the first sealing element 211, and a number of the first mounting slot 212 are the same. By the arrangement of the above structure, when there is one first sealing element 211, the first sealing element 211 can be arranged on an axis where the rotatable connecting member 120 is located. The end of the first sealing element 211 is in contact with the inner surface of the mounting wall. During the opening or closing of the side-hung door, the gap generated by the mounting is covered, which effectively achieves a sealing effect. When there are two first sealing elements 211, the first sealing elements 211 can be arranged on two sides of an axis where the rotatable connecting member 120 is located. The ends of the first sealing elements 211 are in contact with the inner surface of the mounting wall, and an air isolation layer is formed between the two first sealing elements 211 and the inner surface of the mounting wall, to further improve the sealing property of the side-hung door.

In this embodiment, the side-hung door further includes a second sealing element 222. A second mounting slot 223 and a second slot 224 communicated to the second mounting slot 223 are provided in an outer edge of the outer door panel frame 220a. The second sealing element 222 is at least partially inserted into the second mounting slot 223, and the second sealing element 222 is at least partially threaded out along the second slot 224. By the arrangement of the above structure, during the mounting of the side-hung door, the gap generated between the door panel frame 220 and the mounting wall needs to be covered with the second sealing element 222. During assembling, the second sealing element 222 is inserted into the second mounting slot 223, and the second sealing element 222 is threaded out along the second slot 224. The second mounting slot 223 can effectively fix the second sealing element 222 and prevent the second sealing element 222 from falling off during the opening or closing of the side-hung door. The second sealing element 222 threaded out of the second slot 224 protrudes out of an end surface. When the side-hung door is in a closed state, an end of the second sealing element 222 is in contact with an inner surface of the mounting wall to cover the gap generated during the mounting, thereby effectively achieving a sealing effect.

In this embodiment, the second mounting slot 223 and the second slot 224 communicated to the second mounting slot 223 are provided on at least part of the outer edge of the outer door panel frame 220a. By the arrangement of the above structure, during the mounting of the side-hung door, a gap may be caused between the door panel frame 220 and the mounting wall, which can damage the sealing property of the side-hung door. Due to the design of the second sealing element 222, the lack of sealing caused by the gap can be compensated for. However, not all parts of the door panel frame 220 have gaps from the mounting wall. For a part of the door panel frame 220 having a gap, the second mounting slot 223 and the second slot 224 can be provided to insert the second sealing element 222.

In this embodiment, at least one second mounting slot 223 is provided; and a number of the second slot 224, a number of the second sealing element 222, and a number of the second mounting slot 223 are the same. By the arrangement of the above structure, when there is one second sealing element 222, the second sealing element 222 can be arranged on a center line of the outer edge of the door panel frame 220. An end of the second sealing element 222 is in contact with the inner surface of the mounting wall. During the opening and closing of the side-hung door, the gap generated by the mounting is covered, which effectively achieves a sealing effect. When there are two second sealing elements 222, the second sealing elements 222 can be arranged on two sides of a center line of the outer edge of the door panel frame 220. The ends of the second sealing elements 222 are in contact with the inner surface of the mounting wall, and an air isolation layer is formed between the two second sealing elements 222 and the inner surface of the mounting wall, to further improve the thermal insulation performance of the side-hung door.

In this embodiment, the first sealing element 211 and the second sealing element 222 are made of soft materials. By the arrangement of the above structure, the soft materials have good elasticity and good wear resistance. The good elasticity can keep the ends of both the first sealing element 211 and the second sealing element 222 being always in contact with the inner surface of the mounting wall under the action of an elastic reset force, thereby improving the sealing property of the side-hung door. The good wear resistance can prolong the service lives of the sealing elements and prevent problems such as a decreased sealing property caused by wear of the sealing elements, and the like.

In this embodiment, the door panels 300 are at least partially covered at an outer surface of the door frame 200, and shapes and sizes of the door panels 300 are matched with a shape and size of the door frame 200. By the arrangement of the above structure, the shapes and sizes of the door panels 300 are matched with the shape and size of the door frame 200, so that the appearance of the side-hung door is more coordinated and unified, and the overall aesthetics is improved. The close combination between the door panels 300 and the door frame 200 improves the structural stability of the side-hung door. Due to the design of combining the first sealing member 211 with the second sealing member 222, multi-layer sealing can be achieved, and the sealing effect is further enhanced. Preferably, the door panels 300 can be made of a material with a good thermal insulation property to reduce heat loss and enhance the thermal insulation and sealing effects. Preferably, as shown in FIG. 8, FIG. 18, and FIG. 28, to ensure stable connection between the door post frame 210 and the door panel frame 220, the door panels 300 need to have corresponding different thicknesses if the door post frame 210 has different thicknesses, which can achieve cold cutting and thermal isolation effects and improve the thermal insulation performance of the door panels 300.

In this embodiment, two door panels 300 are provided. The two door panels 300 are correspondingly fixed to a front surface and a rear surface of the door panel frame 220. An isolation space 230 is formed between the two door panels 300 and an inner surface of the door panel frame 220. By the arrangement of the above structure, the two door panels 300 are respectively fixed on the front surface and the rear surface of the door panel frame 220, which improves the structural stability of the side-hung door. Meanwhile, the isolation space 230 contains air to form the air isolation layer. Due to the low thermal conductivity of the air, the heat transfer can be effectively slowed down, and the thermal insulation performance of the side-hung door is further improved.

In this embodiment, the door post frame 210 is provided with several cavities 215, and the cavities 215 are configured for thermal isolation. By the arrangement of the above structure, the cavities 215 contains air with low thermal conductivity, which can further enhance the thermal isolation effect of the door post frame 210. Preferably, the door post frame 210 is made of a polyvinyl chloride (PVC) material. Due to a low density of PVC itself, the weight of the door post frame 210 is reduced. In addition, the PVC material has excellent corrosion resistance, high-temperature resistance, good ultraviolet resistance, and the like, which can prolong the service life of the door post frame 210. The PVC material can improve the aesthetics and protective performance of the door post frame 210 through surface treatment such as spraying and lamination.

In this embodiment, at least one observation window 310 is provided in each door panel 300. The observation windows 310 on the two door panels 300 correspond to each other; and a transparent or semi-transparent cover plate is arranged at each observation window 310. By the arrangement of the above structure, due to the observation windows 310 and the transparent or semi-transparent cover plates used to cover the observation windows 310, it can be convenient for a user to easily observe environments inside and outside the side-hung door through the observation windows 310 without opening the side-hung door, and light can be allowed to pass through the observation windows 310.

1. A side-hung door, comprising:
a door frame device, comprising a door post, a rotatable connecting member, and a door frame, wherein the door post is provided with an insertion slot; the rotatable connecting member is inserted into the insertion slot; the door frame comprises a door post frame and a door panel frame; the door post frame is connected to the door panel frame; the door post frame is provided with a positioning slot; the door post is inserted into the positioning slot; the door post is connected to the door panel frame; and
a door panel, wherein the door panel is connected to the door frame, and the door panel is covered at the door frame device.

2. The side-hung door according to claim 1, further comprising two angle brackets, wherein the two angle brackets connect the door post to the door panel frame.

3. The side-hung door according to claim 2, wherein an opening is provided in an outer side of the door post; the angle brackets are of L-shaped structures; one end of each of the two angle brackets is located at each of a top and a bottom of the outer side of the door post, and the other ends of the two angle brackets are respectively located at an upper end and a lower end of an inner side of the door panel frame; and the angle brackets are at least partially located in the opening.

4. The side-hung door according to claim 1, wherein an oblate insertion slot is provided in the door post; the rotatable connecting member is provided with an insertion part; the insertion part is inserted into the insertion slot; and the insertion part is oblate.

5. The side-hung door according to claim 4, wherein the insertion part extends outwards along an upper surface and a lower surface of the door post to form a rotating part, and an end surface of the rotating part is matched with a height of the door panel frame.

6. The side-hung door according to claim 5, wherein the door panel frame is provided with a notch, and the rotating part is located in the notch.

7. The side-hung door according to claim 1, wherein at least one rotatable connecting member is provided.

8. The side-hung door according to claim 1, wherein the door panel frame comprises an outer door panel frame and an inner door panel frame; a shape and size of the inner door panel frame are matched with a shape and size of the outer door panel frame; and the inner door panel frame is nested into the outer door panel frame.

9. The side-hung door according to claim 8, wherein the inner door panel frame is approximately of a rectangular plate-like structure.

10. The side-hung door according to claim 8, wherein the door panel frame comprises a top frame, a bottom frame, and a side frame; and at least two of the top frame, the bottom frame, and the side frame are detachably connected.

11. The side-hung door according to claim 1, further comprising a first sealing element, wherein the door post frame is provided with a first mounting slot and a first slot communicated to the first mounting slot; the first sealing element is at least partially inserted into the first mounting slot; and the first sealing element is at least partially threaded out along the first slot.

12. The side-hung door according to claim 11, wherein at least one first mounting slot is provided; and a number of the first slot, a number of the first sealing element, and a number of the first mounting slot are the same.

13. The side-hung door according to claim 11, further comprising a second sealing element, wherein a second mounting slot and a second slot communicated to the second mounting slot are provided in an outer edge of the outer door panel frame; the second sealing element is at least partially inserted into the second mounting slot; and the second sealing element is at least partially threaded out along the second slot.

14. The side-hung door according to claim 13, wherein the second mounting slot and the second slot communicated to the second mounting slot are provided on at least part of the outer edge of the outer door panel frame.

15. The side-hung door according to claim 13, wherein at least one second mounting slot is provided; and a number of the second slot, a number of the second sealing element, and a number of the second mounting slot are the same.

16. The side-hung door according to claim 13, wherein the first sealing element and the second sealing element are made of soft materials.

17. The side-hung door according to claim 1, wherein the door panel is at least partially covered at an outer surface of the door frame, and a shape and size of the door panel are matched with a shape and size of the door frame.

18. The side-hung door according to claim 1, wherein two door panels are provided; and the two door panels are correspondingly fixed to a front surface and a rear surface of the door panel frame; and an isolation space is formed between the two door panels and an inner surface of the door panel frame.

19. The side-hung door according to claim 1, wherein the door post frame is provided with several cavities, and the cavities are configured for thermal isolation.

20. The side-hung door according to claim 1, wherein at least one observation window is provided in the door panel; the observation windows on the two door panels correspond to each other; and a transparent or semi-transparent cover plate is arranged at each observation window.
